(19) United States
(12) Patent Application Publication
(10) Pub. No.: US 2004/0069018 A1
(43) Pub. Date: Apr. 15, 2004

(54) Optical fiber drawing method using asymmetric control of spin amplitude

(76) Inventors: Sung-Koog Oh, Kumi-shi (KR); Jae-Ho Lee, Kumi-shi (KR)

Correspondence Address: CHA & REITER, LLC, 210 ROUTE 4 EAST STE 103, PARAMUS, NJ, 07652, US

(21) Appl. No.: 10/677,462

(22) Filed: Oct. 2, 2003

(30) Foreign Application Priority Data
Oct. 2, 2002 (KR) 2002-60111

(51) Int. Cl. C03B 37/075

(52) U.S. Cl. 65/402

(57) ABSTRACT

An optical-fiber-drawing method, employed during the manufacturing of an optical fiber from an optical-fiber perform, includes: a step of heating an end of the optical fiber preform to thereby melt and draw the end of the optical-fiber preform; a first spin-forming step, in which a predetermined spin is given to the optical-fiber preform in a predetermined direction that is perpendicular to a direction in which the optical-fiber preform is drawn; and, a second spin-forming step, in which the optical-fiber preform is further twisted according to a predetermined spin function.

### CLAIM OF PRIORITY

This application claims priority to an application entitled “Optical fiber drawing method using asymmetric control of spin amplitude,” filed in the Korean Intellectual Property Office on Oct. 2, 2002 and assigned Ser. No. 2002-60111, the contents of which are hereby incorporated by reference.

### BACKGROUND OF THE INVENTION

1. Field of the Invention

The present invention relates to a method of manufacturing an optical fiber in order to minimize the Polarization-Mode Dispersion (PMD) and, more particularly, to a method of manufacturing an optical fiber, which is twisted at a constant period according to a spin function.

2. Description of the Related Art

Polarization-mode dispersion (PMD) relates to the imperfections of an optical fiber, such as geometric deformation and stress asymmetry, and causes a differential-group delay (DGD) in the speed of the two polarization modes of light in a fiber; that is, the spreading light pulses as it travels in an optical fiber in proportion to the optical fiber's length. This type of a differential-group delay causes the polarization modes of the optical signal to be superposed on each other.

The polarization-mode dispersion is caused by factors such as material dispersion due to the refractivity characteristics of the optical fiber and geometrical defects generated by various stresses, including mechanical stresses due to tension and axial pressure applied to the optical fiber and thermal stress due to the temperature change of the optical fiber.

The polarization-mode dispersion broadens the spectral width of an optical signal and causes mutual interference between optical signals, thus acting as a restrictive factor in an optical communication network employing the wavelength-division-multiplexing (WDM) scheme, which is designed to enable a long-distance transmission by multiplexing a predetermined a wavelength band for optical communication.

In order to minimize the polarization-mode dispersion, an optical fiber may be twisted in several ways during the drawing process of the fabrication stage. That is, an optical fiber may be twisted using a single cycle-spin function or with different cycle-spin functions, where a twist degree of an optical fiber is expressed by the number of turns per unit length. Accordingly, research is being focused on exploring the relationship between the twist degree of an optical fiber and the polarization-mode dispersion in order to minimize the dispersion effects.

U.S. Pat. No. 5,943,466 issued to Henderson, et al., entitled “Frequency and amplitude modulated fiber spins for PMD reduction,” discloses a method of introducing a spin to optical fibers by modulating the amplitude and frequency of the spin. In Henderson's patent, the amplitude and frequency of a spin function are modulated using a sinusoidal function as explained hereinafter.

The following equation 1 shows a spin function in which the frequency term is sinusoidally modulated by adding a sinusoidal function ƒₘ sin(2πz/Λ) to the initial frequency term ƒ₀z.

α(z)=α₀ sin[2π{ƒ₀z+ƒₘ sin(2πz/Λ)}] (Equation 1)

In equation 1, α(z) is a spin function representing the spin period and the spin amplitude given to an optical fiber, wherein α₀ is the spin amplitude in turns/meter, ƒ₀ is the center frequency, ƒₘ is the modulation frequency, Λ is the modulation period, and z is a length measured in a direction along which the optical fiber is drawn. Equation 1 can be analyzed as shown by the following equation 2.

α(z)=α₀ sin(2πƒ₀z) cos[ƒₘ sin(2πz/Λ)}]+α₀cos(2πƒ₀z) sin[ƒₘsin(2πz/Λ)] (Equation 2)

That is to say, the spin function can be expressed by the sum of two sinusoidal functions as shown in equation 2, which implies that the spin function can be expressed by frequency and amplitude-modulated functions, each of which has a shape changing according to ƒₘ and Λ. Further, in each term of equation 2, the frequency and amplitude are sinusoidally modulated.

α(z)=[α₀sin(2πz/Λ)]sin(2πƒz) (Equation 3)

Referring to FIGS. 1 and 2, which are graphs reflecting equation 3, FIG. 1 shows a frequency modulation in a higher order, while FIG. 2 shows a frequency modulation in a lower order. Further, FIGS. 1 and 2 show the amplitude modulation of sinusoidal functions, which means that the term [α₀ sin(2πz/Λ)] in equation 2 relates to the modulation, and the graphs of spin functions in which the number of turns per unit length of an optical fiber has been modulated in the form of sinusoidal functions.

However, in the conventional method of modulating the amplitude and frequency of the spin, it is impossible to asymmetrically modulate the number of turns and the direction of the spin as the amplitude and frequency of the spin is modulated according to a sinusoidal function. In addition, both the first-order polarization-mode distribution representing the distance-based polarization-mode distribution and the second-order polarization-mode distribution representing the wavelength-based polarization-mode distribution occurs. As such, signals interfere with each other during the transmission in a long-distance optical communication network of a wavelength-division-multiplexing type.

Therefore, there is a need for a new method for drawing an optical fiber that can minimize the polarization-mode dispersion.

### SUMMARY OF THE INVENTION

The present invention overcomes the above-described problems, and provides additional advantages, by providing a method for giving a spin to optical fibers, so that both the primary polarization-mode dispersion affected by the light-traveling distance and the secondary polarization-mode dispersion affected by the wavelength of light can be controlled properly.

One aspect of the invention is to provide an optical-fiber-drawing method using an asymmetric control of the spin amplitude which can be employed during the manufacturing process of an optical fiber from an optical-fiber preform. The optical-fiber-drawing method comprising: a step of heating one end of the optical-fiber preform to thereby melt and draw the optical-fiber preform; a first spin-forming step, in which a predetermined spin is given to the optical-fiber preform in a predetermined direction that is perpendicular to a direction in which the optical-fiber preform is drawn; and, a second spin-forming step, in which the optical-fiber preform is further twisted according to a predetermined spin function.

### BRIEF DESCRIPTION OF THE DRAWINGS

The above features and advantages of the present invention will be more apparent from the following detailed description taken in conjunction with the accompanying drawings, in which:

FIG. 1 is a graph showing an example of a spin-amplitude modulation according to a conventional sinusoidal-spin function;

FIG. 2 is a graph showing an example of a spin-amplitude modulation according to another conventional sinusoidal-spin function;

FIG. 3 is a graph showing the spin functions having different periods according to an embodiment of the present invention;

FIG. 4 is a graph showing the polarization-mode dispersion difference according to the length of an optical fiber;

FIG. 5 is a side view of a wheel giving an initial angle and a spin to an optical fiber according to an embodiment of the present invention; and, FIG. 6 is a side view of a first wheel giving an initial angle to an optical fiber and a second wheel giving spin to the optical fiber according to an embodiment of the present invention.

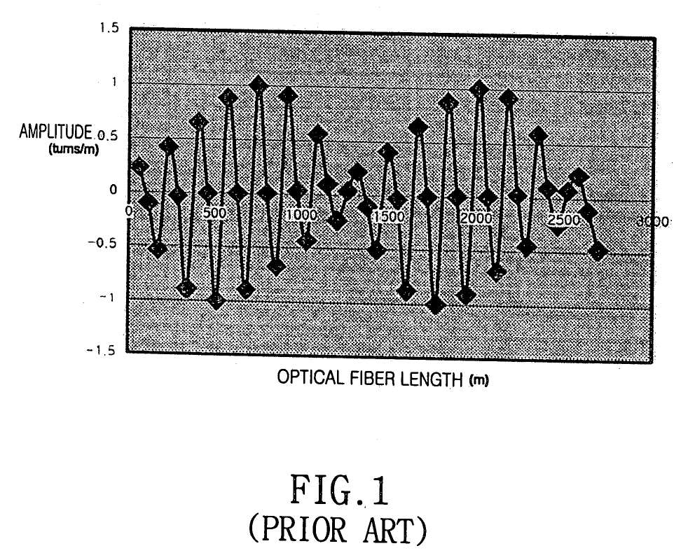

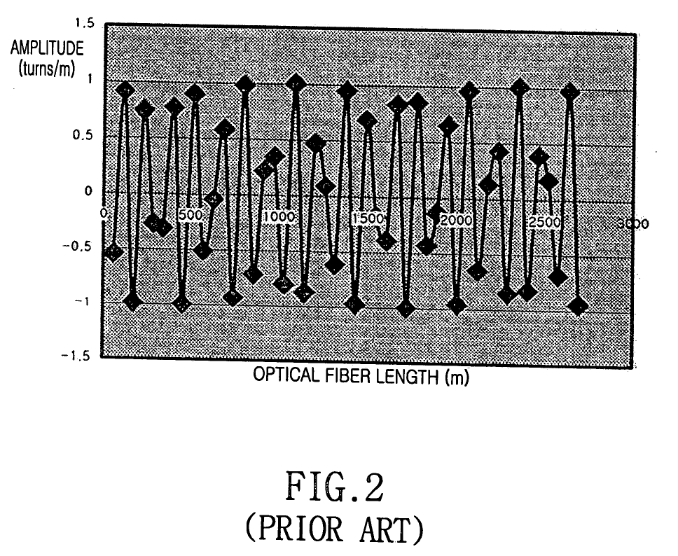

### DETAILED DESCRIPTION OF THE PREFERRED EMBODIMENT

Hereinafter, preferred embodiments of the present invention will be described with reference to the accompanying drawings. For the purposes of clarity and simplicity, a detailed description of known functions and configurations incorporated herein will be omitted as it may make the subject matter of the present invention unclear.

Equation 4 shows the sum of a spin function and an integral amplitude, where the spin function has a predetermined frequency and amplitude.

S(z)=α₀ Sin(2πƒ₀)+nα (Equation 4)

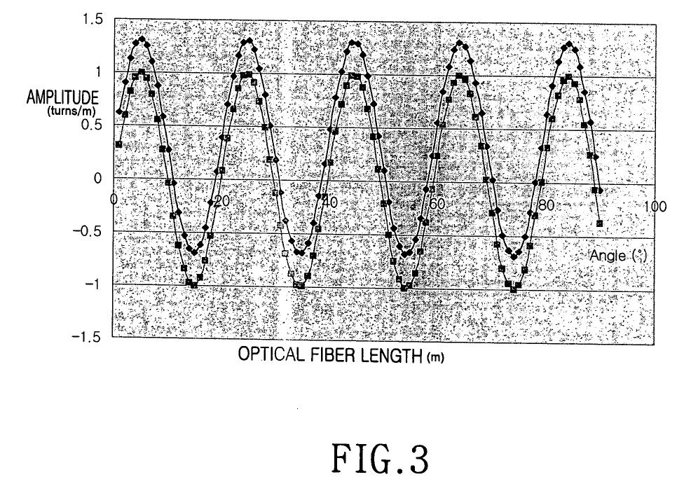

In equation 4, S(z) is a spin function representing the spin period and the spin amplitude given to an optical fiber, where α₀ is the spin amplitude in turns/meter, ƒ₀ is the center frequency, and a indicates an integer-form degree by which the spin function has moved as shown in FIG. 3.

By utilizing the spin function of Equation 4, a method of fabricating an optical fiber from an optical-fiber preform according to the teachings of the present invention comprises: a step (a) of melting and drawing an optical-fiber preform by heating one end of the optical-fiber preform; a first spin-forming step(b); and, a second spin-forming step(c).

In the melting and drawing step (a), one end of the optical-fiber preform is heated for melting and is then drawn.

In the first spin-forming step (b), a predetermined spin is given to the optical-fiber preform in a predetermined direction that is perpendicular to the direction in which the optical-fiber preform is drawn. That is, the optical-fiber preform is twisted in a clockwise or counter-clockwise direction that is perpendicular to the direction in which the optical-fiber preform is drawn. The first spin-forming step corresponds to the term nα in equation 4, which means that the optical-fiber is twisted at a constant rate during a predetermined interval in the course of drawing the optical-fiber perform.

In the second spin-forming step(c), the optical-fiber preform, which has been subjected to the first spin-forming step, is further twisted according to a predetermined spin function.

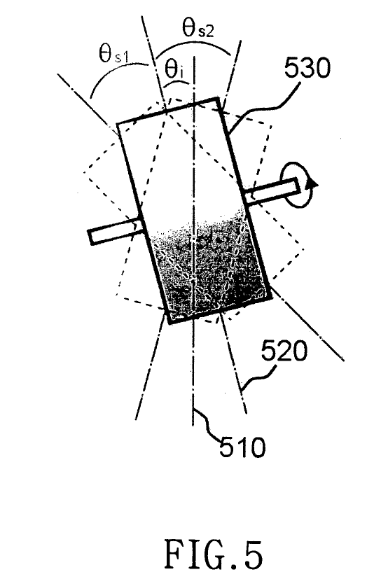

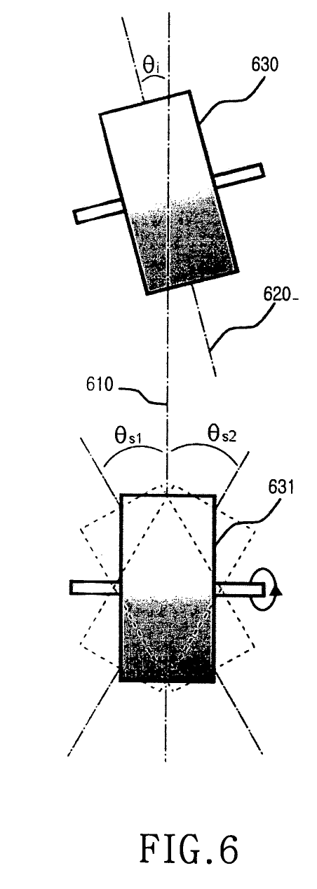

Briefly, referring to FIG. 5, a wheel 530 is located in such a manner that a central axis of the wheel 530 coincides with a tilt axis 520 inclined at a predetermined initial angle θᵢ with respect to an optical-fiber-drawing axis 510, so that the predetermined initial angle θᵢ set in a single direction is given to the optical fiber. Then, the wheel 530 is rotated while swinging between the vertical inclination angles θₛ₁ and θₛ₂ with reference to the tilt axis 520 inclined at the initial angle θᵢ with respect to the optical-fiber-drawing axis 510, which are determined by equation 3, so that a spin minimizing polarization-mode dispersion is given to the optical fiber. That is, the wheel 530 for giving spin to the optical fiber is first inclined at a predetermined initial angle θᵢ, and is then rotated while swinging between vertical inclination angles θₛ₁ and θₛ₂, so that a spin according to equation 4 is given to the optical fiber while the optical fiber is being drawn.

In the method described above, which employs asymmetric control of the spin amplitude, the optical-fiber preform is twisted with different numbers of turns in the first and second spin-forming steps. In other words, while the optical-fiber preform is being drawn, the optical-fiber preform may be twisted with a predetermined number of turns in the first spin-forming step, then the optical-fiber preform may be twisted with another number of turns that is different from the second spin-forming step. For example, the optical-fiber preform may be twisted with a number of turns and in a direction, which are determined by the term n α, in the first spin-forming step, then the optical-fiber preform may be twisted with a different number of turns and in a different direction, which are determined by the term α₀ Sin(2πƒ₀), in the second spin-forming step, so that asymmetric double-spins having different spin directions and different turn numbers are given to the optical-fiber preform, thereby not only reducing the first polarization-mode dispersion and deviation but also improving the second polarization-mode dispersion characteristic of the optical fiber.

Now, the operations steps according to the present invention is explained hereinafter.

Referring to FIG. 6, a first wheel 630 is located in such a manner that a central axis of the first wheel 630 coincides with a tilt axis 620 inclined at a predetermined initial angle θᵢ with respect to an optical-fiber-drawing axis 610, and a separate second wheel 631 is so disposed as to twist the optical fiber which is being drawn while being inclined at the initial angle θᵢ by the first wheel 630.

The first wheel 630 is inclined at the predetermined initial angle θᵢ with respect to the optical-fiber-drawing axis 610, so as to provide the initial angle for the optical fiber drawn from the first wheel 630.

The second wheel 631 swings between vertical inclination angles θₛ₁ and θₛ₂ with reference to the optical-fiber-drawing axis 610, which are determined by the spin function as expressed by equation 3. That is, a spin according to equation 4 is given to the optical fiber being drawn while being inclined at the initial angle θᵢ of the first wheel 630, so that an optical fiber having frequency and amplitude-modulated spins can be fabricated.

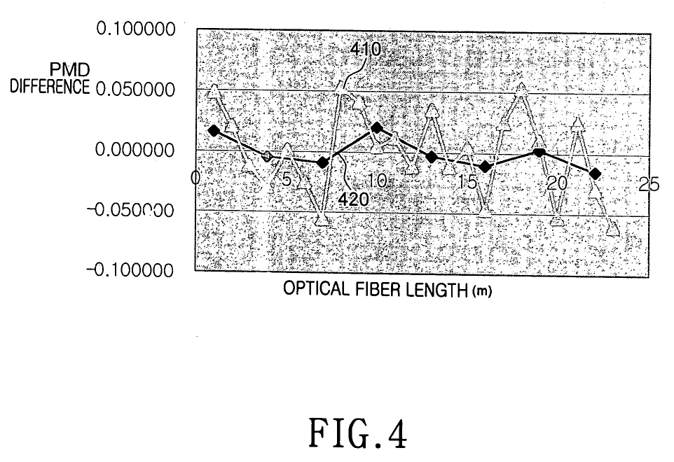

Referring to FIG. 4 showing the polarization-mode dispersion difference according to the length of an optical fiber, it is appreciated that the polarization-mode dispersion 420 in an optical fiber fabricated according to the inventive method of drawing an optical fiber using spin-amplitude modulation is smaller than the polarization-mode dispersion 410 in an optical fiber fabricated by the conventional method.

According to the teachings of the present invention, while an optical fiber is being drawn, a first spin is given to the optical fiber, and then a second spin is given additionally to the optical fiber according to a spin function, thereby minimizing not only the primary polarization-mode dispersion depending on distance, but also the secondary polarization-mode dispersion occurring in dependence upon the wavelength.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for drawing an optical fiber from an optical-fiber preform, the method comprising:
a step of heating one end of the optical-fiber preform for melting and drawing the end of the optical-fiber preform;
a first spin-forming step for applying a first predetermined spin to the optical-fiber preform in a first predetermined direction that is perpendicular to a direction in which the optical-fiber preform is drawn; and,
a second spin-forming step for applying a second predetermined spin to the optical-fiber preform in a second predetermined direction according to a predefined spin function.

2. The method as claimed in claim 1, wherein the optical-fiber preform is twisted with different numbers of turns in the first and second spin-forming steps.

3. The method as claimed in claim 1, wherein the optical-fiber preform is subjected to the spin-forming step between the first and the second predetermined directions according to the following equation:
S(z)=α₀ Sin(2πƒ_{0)+nα,}
where S(z) represents a spin function, α₀ represents a spin amplitude in turns/meter, ƒ₀ represents the center frequency, and a represents an integer.

4. The method as claimed in claim 3, wherein the first spin-forming step is performed according to the term defined by: nα of the S(z) equation.

5. The method as claimed in claim 3, wherein the second spin-forming step is performed according to the term defined by: Ε₀ Sin(2πƒ₀) of the S(z) equation.
